(19) United States
(12) Patent Application Publication
(10) Pub. No.: US 2026/0270859 A1
(43) Pub. Date: Sep. 10, 2026

(54) SIGNALING FOR USER EQUIPMENT ANTENNA SUBSET SELECTION

(71) Applicant: QUALCOMM Incorporated, San Diego, CA (US)

(72) Inventors: Narayan PRASAD, Westfield, NJ (US); Mostafa KHOSHNEVISAN, San Diego, CA (US); Tao LUO, San Diego, CA (US); Junyi LI, Greentown, PA (US)

(21) Appl. No.: 19/555,696

(22) Filed: Mar. 3, 2026

Related U.S. Application Data
(60) Provisional application No. 63/769,581, filed on Mar. 10, 2025.

(51) Int. Cl. H04W 48/20; H04L 5/00; H04W 72/21

(52) U.S. Cl. CPC H04W 48/20; H04L 5/0048; H04W 72/21

(57) ABSTRACT

This disclosure provides methods, components, devices and systems for signaling for user equipment (UE) antenna subset selection. For example, a UE may select one or more subsets of antenna ports for transmission, reception, or both, in response to receiving control information and one or more downlink reference signals from a network entity. The control information may indicate one or more subsets of network entity antenna ports for the UE to consider for uplink evaluation, downlink evaluation, or a combination thereof. The control information also may indicate one or more conditions of an uplink channel between the UE and the network entity, a calibration adjustment associated with the network entity, or both. The UE may select subsets of antenna ports for each of the indicated subsets of network entity antenna ports using the one or more conditions of the uplink channel and the calibration adjustment.

### CROSS REFERENCES

The present Application for Patent claims benefit of U.S. Provisional Patent Application No. 63/769,581 by PRASAD et al., entitled “SIGNALING FOR USER EQUIPMENT ANTENNA SUBSET SELECTION,” filed Mar. 10, 2025, assigned to the assignee hereof, and expressly incorporated herein.

### TECHNICAL FIELD

This disclosure relates generally to wireless communication, and more specifically to systems, devices, methods, and techniques associated with signaling for user equipment (UE) antenna subset selection.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

In some wireless communication systems, a network entity may indicate one or more subsets of antennas for a UE to use for communication with the network entity based on uplink channel measurements, downlink channel measurements, or both.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include receiving, at the UE, control information indicating one or more conditions of an uplink channel between the UE and a network entity, a calibration adjustment associated with the network entity, one or more subsets of network entity antenna ports for uplink evaluation, or one or more subsets of network entity antenna ports for downlink evaluation, or a combination thereof, receiving, at the UE, one or more downlink reference signals via a downlink channel between the UE and the network entity, and communicating, at the UE, with the network entity using one or more antenna ports selected by the UE in response to receiving the control information and the one or more downlink reference signals.

A UE for wireless communications is described. The UE may include a processing system that includes processor circuitry and memory circuitry that stores code. The processing system may be configured to cause the UE to receive, at the UE, control information indicating one or more conditions of an uplink channel between the UE and a network entity, a calibration adjustment associated with the network entity, one or more subsets of network entity antenna ports for uplink evaluation, or one or more subsets of network entity antenna ports for downlink evaluation, or a combination thereof, receive, at the UE, one or more downlink reference signals via a downlink channel between the UE and the network entity, and communicate, at the UE, with the network entity using one or more antenna ports selected by the UE in response to receiving the control information and the one or more downlink reference signals.

Another UE for wireless communications is described. The UE may include means for receiving, at the UE, control information indicating one or more conditions of an uplink channel between the UE and a network entity, a calibration adjustment associated with the network entity, one or more subsets of network entity antenna ports for uplink evaluation, or one or more subsets of network entity antenna ports for downlink evaluation, or a combination thereof, means for receiving, at the UE, one or more downlink reference signals via a downlink channel between the UE and the network entity, and means for communicating, at the UE, with the network entity using one or more antenna ports selected by the UE in response to receiving the control information and the one or more downlink reference signals.

A non-transitory computer-readable medium storing code for wireless communications is described. The code may include instructions executable by one or more processors to receive, at the UE, control information indicating one or more conditions of an uplink channel between the UE and a network entity, a calibration adjustment associated with the network entity, one or more subsets of network entity antenna ports for uplink evaluation, or one or more subsets of network entity antenna ports for downlink evaluation, or a combination thereof, receive, at the UE, one or more downlink reference signals via a downlink channel between the UE and the network entity, and communicate, at the UE, with the network entity using one or more antenna ports selected by the UE in response to receiving the control information and the one or more downlink reference signals.

In some examples of the method, UEs, and non-transitory computer-readable medium described herein, communicating with the network entity using the one or more antenna ports may include operations, features, means, or instructions for transmitting uplink communication using a first subset of antenna ports of a set of multiple antenna ports of the UE, the one or more antenna ports including the first subset of antenna ports and receiving downlink communication using a second subset of antenna ports of the set of multiple antenna ports of the UE, the one or more antenna ports including the second subset of antenna ports.

Some examples of the method, UEs, and non-transitory computer-readable medium described herein may further include operations, features, means, or instructions for selecting the one or more antenna ports from a set of multiple antenna ports based on the control information indicating the one or more subsets of network entity antenna ports for uplink evaluation, the one or more subsets of network entity antenna ports for downlink evaluation, or both and transmitting an indication of a quantity of the one or more antenna ports for the one or more subsets of network entity antenna ports for uplink evaluation, downlink evaluation, or both, one or more computed parameters of the uplink channel or the downlink channel, a quantity of the one or more antenna ports selected for a portion of the one or more subsets of network entity antenna ports for uplink evaluation, downlink evaluation, or both, an identifier of the one or more antenna ports for the one or more subsets of network entity antenna ports for uplink evaluation, downlink evaluation, or both, an identifier of the one or more antenna ports for each subset in the portion of the one or more subsets of network entity antenna ports for uplink evaluation, downlink evaluation, or both, or a combination thereof.

Some examples of the method, UEs, and non-transitory computer-readable medium described herein may further include operations, features, means, or instructions for receiving a feedback message based on transmitting the indication, where uplink reference signal control information, uplink grant information, or both may be based on receiving the feedback message.

A method for wireless communications by a network entity is described. The method may include transmitting, from the network entity, control information indicating one or more conditions of an uplink channel between a UE and the network entity, a calibration adjustment associated with the network entity, one or more subsets of network entity antenna ports for uplink evaluation, or one or more subsets of network entity antenna ports for downlink evaluation, or a combination thereof, transmitting, from the network entity, one or more downlink reference signals via a downlink channel between the UE and the network entity, and communicating, at the network entity, with the UE in response to transmitting the control information and the one or more downlink reference signals.

A network entity for wireless communications is described. The network entity may include a processing system that includes processor circuitry and memory circuitry that stores code. The processing system may be configured to cause the network entity to transmit, from the network entity, control information indicating one or more conditions of an uplink channel between a UE and the network entity, a calibration adjustment associated with the network entity, one or more subsets of network entity antenna ports for uplink evaluation, or one or more subsets of network entity antenna ports for downlink evaluation, or a combination thereof, transmit, from the network entity, one or more downlink reference signals via a downlink channel between the UE and the network entity, and communicate, at the network entity, with the UE in response to transmitting the control information and the one or more downlink reference signals.

Another network entity for wireless communications is described. The network entity may include means for transmitting, from the network entity, control information indicating one or more conditions of an uplink channel between a UE and the network entity, a calibration adjustment associated with the network entity, one or more subsets of network entity antenna ports for uplink evaluation, or one or more subsets of network entity antenna ports for downlink evaluation, or a combination thereof, means for transmitting, from the network entity, one or more downlink reference signals via a downlink channel between the UE and the network entity, and means for communicating, at the network entity, with the UE in response to transmitting the control information and the one or more downlink reference signals.

A non-transitory computer-readable medium storing code for wireless communications is described. The code may include instructions executable by one or more processors to transmit, from the network entity, control information indicating one or more conditions of an uplink channel between a UE and the network entity, a calibration adjustment associated with the network entity, one or more subsets of network entity antenna ports for uplink evaluation, or one or more subsets of network entity antenna ports for downlink evaluation, or a combination thereof, transmit, from the network entity, one or more downlink reference signals via a downlink channel between the UE and the network entity, and communicate, at the network entity, with the UE in response to transmitting the control information and the one or more downlink reference signals.

In some examples of the method, network entities, and non-transitory computer-readable medium described herein, communicating with the UE may include operations, features, means, or instructions for receiving uplink communication associated with a first subset of antenna ports of a set of multiple antenna ports of the UE and transmitting downlink communication associated with a second subset of antenna ports of the set of multiple antenna ports of the UE.

Some examples of the method, network entities, and non-transitory computer-readable medium described herein may further include operations, features, means, or instructions for transmitting second control information indicating the calibration adjustment associated with the network entity based on the control information indicating the one or more conditions of the uplink channel between the UE and the network entity, where communicating with the UE may be further in response to transmitting the second control information.

Some examples of the method, network entities, and non-transitory computer-readable medium described herein may further include operations, features, means, or instructions for receiving an indication of a quantity of antenna ports of the UE associated with the one or more subsets of network entity antenna ports for uplink evaluation, downlink evaluation, or both, one or more computed parameters of the uplink channel or the downlink channel, a quantity of antenna ports of the UE associated with a portion of the one or more subsets of network entity antenna ports for uplink evaluation, downlink evaluation, or both, an identifier of the antenna ports of the UE for the one or more subsets of network entity antenna ports for uplink evaluation, downlink evaluation, or both, an identifier of the antenna ports of the UE for each subset in the portion of the one or more subsets of network entity antenna ports for uplink evaluation, downlink evaluation, or both, or a combination thereof.

Some examples of the method, network entities, and non-transitory computer-readable medium described herein may further include operations, features, means, or instructions for transmitting a feedback message based on receiving the indication, where uplink reference signal control information, uplink grant information, or both, may be based on transmitting the feedback message.

### BRIEF DESCRIPTION OF THE DRAWINGS

FIG. 1 shows an example of a wireless communication system.

FIG. 2 shows an example of a signaling configuration that supports signaling for user equipment (UE) antenna subset selection.

FIG. 3 shows an example of a process flow that supports signaling for UE antenna subset selection.

FIG. 4 shows a diagram of a processing system that supports signaling for UE antenna subset selection.

FIG. 5 shows a diagram of a system including a device that supports signaling for UE antenna subset selection.

FIG. 6 shows a diagram of a processing system that supports signaling for UE antenna subset selection.

FIG. 7 shows a diagram of a system including a device that supports signaling for UE antenna subset selection.

FIGS. 8 and 9 show flowcharts illustrating methods that support signaling for UE antenna subset selection.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may receive downlink communications from a network entity via a downlink channel between the UE and the network entity and transmit uplink communications to the network entity via an uplink channel between the UE and the network entity. Both the UE and the network entity may communicate using one or more antenna ports at each device. In some examples, the network entity may select which of the antenna ports the UE uses for uplink and downlink communications based on communication of downlink reference signals via the downlink channel and uplink reference signals via the uplink channel. However, as a quantity of antenna elements at one or both of the UE and the network entity increases, such antenna port selection may be associated with relatively increasing processing and signaling overhead.

Aspects of the subject matter described in this disclosure relate to a UE selecting one or more subsets of antenna ports for transmission, reception, or both, in response to receiving control information and one or more downlink reference signals (e.g., from a network entity). For example, the control information may indicate one or more subsets of network entity antenna ports for the UE to consider for uplink evaluation, one or more subsets of network entity antenna ports for the UE to consider for downlink evaluation, or a combination thereof. Each subset of network entity antenna ports for uplink evaluation or downlink evaluation may be referred to as a hypothesis or sub-configuration. Additionally, or alternatively, the control information may indicate one or more conditions of the uplink channel (e.g., a noise plus interference observed at a receive port of the network entity), a calibration adjustment associated with the network entity, or both. The UE may select subsets of antenna ports for uplink or downlink for each of the indicated subsets of network entity antenna ports using the one or more conditions of the uplink channel and the calibration adjustment.

In some examples, the UE may report an indication of the selected subsets of antenna ports, one or more computed uplink or downlink metrics (e.g., computed metrics used to select the subsets of antenna ports), or a combination thereof. For example, the report may indicate a quantity of selected antenna ports for each hypothesis indicated in the control information. Additionally, or alternatively, the report may indicate a composition (e.g., quantity and identifier) of the selected antenna ports for each hypothesis. The network entity may transmit a feedback message in response to the report, and the feedback message may indicate a selected hypothesis or other communication information (e.g., the feedback message may indicate an uplink reference signal configuration or an uplink grant).

Particular aspects of the subject matter described in this disclosure can be implemented to realize one or more of the following potential advantages. In some examples, by enabling a UE to select one or more subsets of antenna ports for communication, the described techniques can be used to reduce signaling overhead (e.g., selection may be based on downlink reference signals). In some examples, by selecting and reporting the one or more subsets of antenna ports based on the one or more hypotheses indicated in the control information, the described techniques can be used to increase network energy savings because a network entity may know a quantity of antenna ports to use to effectively communicate with a UE (e.g., the UE may select antenna ports that satisfy a communication quality threshold).

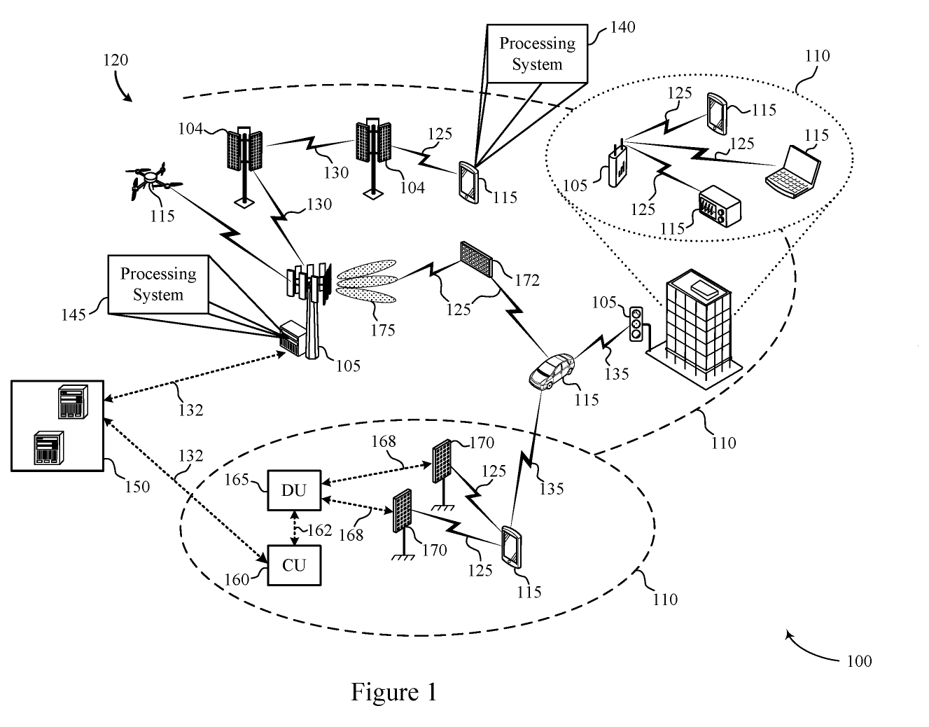

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for signaling for UE antenna subset selection. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support a UE 115 selecting one or more subsets of antenna ports for communications in response to receiving control information and one or more downlink reference signals. By enabling the UE 115 to select the one or more subsets of antenna ports, the described techniques may be used to reduce signaling overhead and increase network energy savings at a network entity 105, among other advantages.

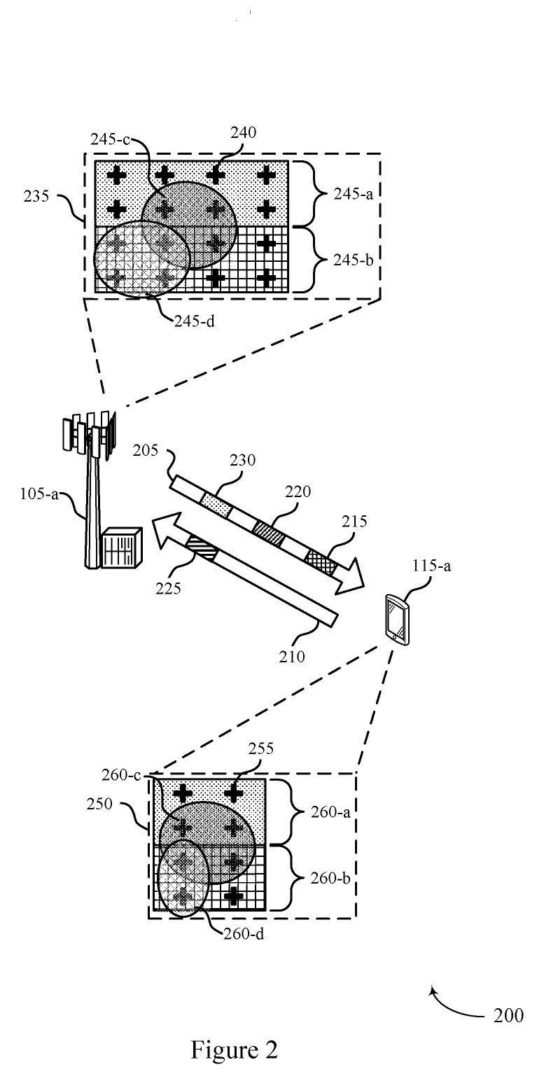

FIG. 2 shows an example of a signaling configuration 200 that supports signaling for UE antenna subset selection. The signaling configuration 200 may implement or be implemented by aspects of the wireless communication system 100. For example, the signaling configuration 200 may include a UE 115-a and a network entity 105-a, which may be examples of the corresponding devices described herein, including with reference to FIG. 1.

In some examples, the UE 115-a may receive downlink communications via a downlink channel 205 between the UE 115-a and the network entity 105-a and transmit uplink communications via an uplink channel 210 between the UE 115-a and the network entity 105-a. The network entity 105-a may receive the uplink communications, or transmit the downlink communications, using an antenna array 235 (e.g., an antenna panel) that includes one or more antenna ports 240. Similarly, the UE 115-a may transmit the uplink communications, or receive the downlink communications, using an antenna array 250 that includes one or more antenna ports 255. In some examples, the antenna array 235 may have distributed sub-arrays with each subarray including one or more antenna ports 240 and located at a different location, the subarrays being connected to each other via a wireline connection (such as using fiber).

In some other wireless communication systems, a network entity 105 may indicate which of the one or more antenna ports 255 a UE 115 is to use for uplink, downlink, or both, based on communicating one or more reference signals with the UE 115. For example, the network entity 105 may select one or more antenna ports 255 of the UE 115 based on one or more CSI-RSs, one or more SRSs, or both. However, as a quantity of antenna ports 240 and 255 increases at the network entity 105, the UE 115, or both, such antenna port selection may be associated with relatively increasing processing and signaling overhead, and a relatively inefficient use of resources.

The techniques described herein support the UE 115-a selecting one or more subsets 260 of antenna ports 255 for transmission, reception, or both, in response to receiving control information 215 (e.g., one or more instances of control signaling, one or more types of control signaling, one or more fields of control signaling, concurrent control signaling or control signaling communicated at different times) and one or more downlink reference signals 220. In some examples, the control information 215 may indicate different subsets 245 of antenna ports 240 (e.g., at the network entity 105-a) for the UE 115-a to consider (e.g., evaluate, compute) for its transmit antenna port subset selection, downlink antenna port subset selection, or both. For example, the control information 215 may indicate that the UE 115-a is to consider a subset 245-a of antenna ports 240 for downlink (e.g., for UE receive antenna subset selection), a subset 245-b of antenna ports 240 and/or a subset 245-c of antenna ports 240 for uplink (e.g., for UE transmit antenna subset selection), and a subset 245-d of antenna ports 240 for uplink and downlink (e.g., for UE transmit and receive antenna subset selection, which may be indicated as a common subset in the control information 215). As described herein, an indicated subset 245 of antenna ports 240 may be referred to as a hypothesis (e.g., because the UE 115-a is considering the subset of network entity antenna ports 240 for the uplink and/or downlink) or sub-configuration (e.g., of the control information 215, a portion of the control information 215, one or more fields of the control information 215).

The network entity 105-a may indicate (e.g., in the control information 215) a network entity-side calibration adjustment coefficient for each underlying antenna port 240 in the union of the one or more subsets 245 of antenna ports 240. For each respective antenna port 240, a network entity-side calibration coefficient may be a complex-valued scalar that may model a mismatch between transmit and receive RF chains at the network entity 105-a when connected to that respective antenna port 240. In some examples, the network entity 105-a may indicate the network entity-side calibration adjustment coefficients using a pre-defined order (e.g., in accordance with an increasing order of port indices) such that the network entity 105-a may not include port identifiers in the control information 215.

Additionally, or alternatively, the network entity 105-a may indicate (e.g., in control information 215) a noise plus interference matrix for each subset 245, which may model the noise plus interference seen by the network entity 105-a when receiving on antenna ports 240 in that subset 245. The network entity 105-a may indicate the interference plus noise using a pre-defined order. For example, network entity port subsets <1,2> and <2,3,4> may be indicated as subsets 245 to be considered for uplink transmission antenna selection by the UE 115-a. Diagonal elements may be conveyed first in the order (1,1,), (2,2), (3,3), and (4,4), and may be followed by off-diagonal covariance elements (1,2), (2,3), (2,4), and (3,4). In some examples, the network entity 105-a may use the Hermitian property of covariance to indicate the interference plus noise. In some examples, the network entity 105-a may indicate, for each subset, multiple noise plus interference matrices, each matrix being associated with a distinct frequency sub-band.

The UE 115-a may select one or more subsets 260 of antenna ports 255 for uplink communication, downlink communication, or both, for each of the hypotheses indicated in the control information 215. For example, the UE 115-a may select a subset 260-a for a first hypothesis, a subset 260-b for a second hypothesis, a subset 260-c for a third hypothesis, and a subset 260-d for a fourth hypothesis. The UE 115-a may report its selections, as well as any computed uplink channel metrics, downlink channel metrics, or both, in an indication 225 (e.g., one or more indications 225, one or more indication instances, one or more types of indications 225) to the network entity 105-a. In response to the indication 225, the network entity 105-a may transmit a feedback message 230 that acknowledges the indication 225 and, in some examples, may indicate a selected hypothesis or sub-configuration. By enabling the UE 115-a to select the one or more subsets 260 of antenna ports 255 for communication, the described techniques can be used to reduce signaling overhead (e.g., a selection may be based on downlink reference signals rather than a combination of uplink and downlink reference signals). Additionally, by selecting and reporting the one or more subsets 260 of antenna ports 255 based on the one or more hypotheses indicated in control information 215, the described techniques can be used to increase network energy savings because the network entity 105-a may know a quantity (e.g., minimum quantity) of antenna ports 240 to use for communications with the UE 115-a.

In some examples, each antenna element (e.g., associated with a port 240 or a port 255) of the network entity 105-a or the UE 115-a may be connected with a respective RF chain, and an input at a power amplifier of each antenna element may be a phase-weighted sum of all RF chain outputs of a respective device. In some other examples, each antenna element may be a scaled phase-weighted output of a respective RF chain (e.g., each antenna element may have its own dedicated power amplifier as in FR2 or one power amplifier may drive several antenna elements). In some cases, an input at the power amplifier of each antenna element may be the phase-weighted output of any selected RF chain. Additionally, or alternatively, RF chains may be divided into multiple (G) groups and a set of antenna elements may be partitioned into G groups, where each group of RF chains may be assigned a distinct group of antennas, and where within a group the architecture is fully-connected.

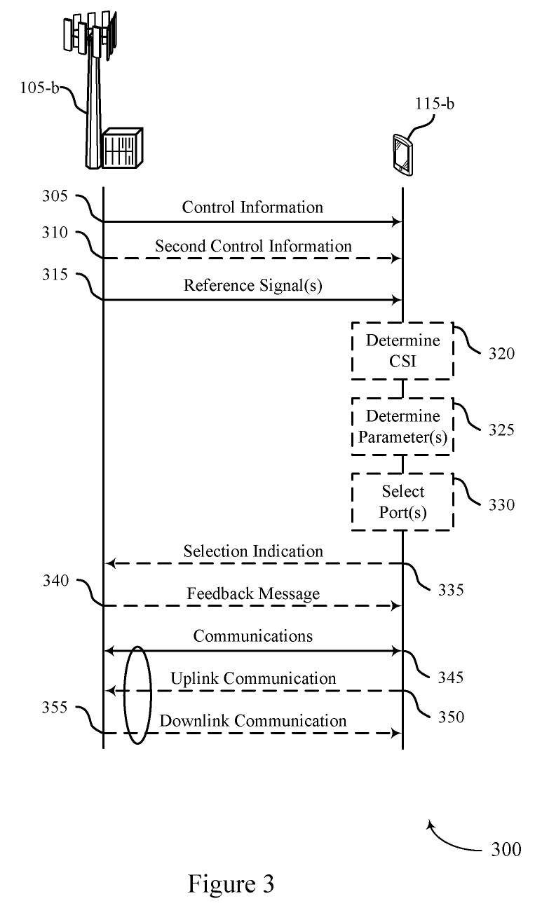

FIG. 3 shows an example of a process flow 300 that supports signaling for UE antenna subset selection. The process flow 300 may implement or be implemented by aspects of any of the wireless communication system 100 or the signaling configuration 200. For example, the process flow 300 includes a network entity 105-b and a UE 115-b, which may be examples of corresponding devices described herein, including with reference to FIGS. 1 and 2. In the following description of the process flow 300, operations between the network entity 105-b and the UE 115-b may be added, omitted, or performed in a different order (e.g., relative to the order shown).

At 305, the network entity 105-b may transmit control information (e.g., control information 215), which may be received by the UE 115-b. In some examples, the control information of 305 may include a CSI-RS resource configuration. For example, the control information may include one CSI-RS resource set with repetition set optionally to ‘ON’ (e.g., based on an analog beamforming span reported in a UE capability message from the UE 115-b, not shown). An analog beamforming span may be a maximum quantity of antenna elements with an independent analog phase, amplitude control, or both, that an RF chain may be connected with. The CSI-RS resource set may include all CSI-RS resources the network entity 105-b transmits using T reference ports (e.g., T may be a total quantity of antenna ports of the network entity 105-b). The control information may indicate the quantity T to the UE 115-b.

Additionally, or alternatively, the control information of 305 may indicate one or more subsets (e.g., subset(s) 245) of network entity antenna ports (e.g., port(s) 240) for uplink evaluation, one or more subsets of network entity antenna ports for downlink evaluation, or a combination thereof. For example, the control information may indicate multiple subsets of the T reference ports, with each subset of network entity antenna ports being marked as consideration for the UE 115-b for downlink communication (the UE 115-b may consider or evaluate the network entity antenna ports in the respective subset as transmit ports), marked as consideration for the UE 115-b for uplink communication (the UE 115-b may consider or evaluate the network entity antenna ports in the respective subset as receive ports), or marked as consideration for by the UE 115-b for both uplink and downlink communication. The one or more subsets of network entity antenna ports for uplink evaluation, downlink evaluation, or both, may be defined based on a common reference signal resource set (e.g., based on T CSI-RS ports of one CSI-RS resource set). In some other cases, the one or more subsets of network entity antenna ports for uplink evaluation, downlink evaluation, or both, may be defined based on multiple subsets of network entity antenna ports from multiple CSI-RS resources.

Additionally, or alternatively, the control information of 305 may indicate one or more conditions of an uplink channel (e.g., an uplink channel 210) between the UE 115-b and the network entity 105-b, a calibration adjustment associated with the network entity 105-b, or a combination thereof. For example, the one or more conditions of the uplink channel may include a noise plus interference covariance matrix (e.g., a matrix Rnn). The network entity 105-b may estimate Rnn, which may be the noise plus interference evaluated by the network entity 105-b for reception in the uplink channel (for instance, this evaluation may be done for wideband so that a common Rnn matrix is obtained for all sub-bands). The network entity 105-b may indicate Rnn as a full matrix or as diagonal elements for UE computation of uplink channel metrics. In some examples, the network entity 105-b may indicate multiple noise plus interference matrices, each matrix being associated with a distinct frequency sub-band and being estimated based on the noise plus interference evaluated by the network entity 105-b for reception in the uplink channel on that sub-band (e.g., a distinct Rnn matrix is obtained for each sub-band).

A calibration adjustment indicated by the control information of 305 may be a diagonal matrix of calibration coefficients, each of which may model a mismatch between transmit and receive RF chains, respectively, connected to a same port (e.g., a port 240 at the network entity 105-b, a port 255 at the UE 115-b). The UE 115-b may use the calibration adjustment to account for deviations in channel reciprocity between the UE 115-b and the network entity 105-b or for a mismatch in the receive and transmit RF chains of the network entity 105-b (e.g., mismatch in the gains or attenuations or distortions introduced by components such as amplifiers or converters in the receive and transmit RF chains, respectively, of the network entity 105-b). For example, because the UE 115-b may be computing metrics based on downlink reference signals, the UE 115-b may be unaware of uplink conditions at network entity ports 240 for reception. The network entity 105-b may absorb the calibration adjustment in Rnn (e.g., the control information of 305 may indicate Rnn that includes the calibration adjustment). In some examples, the network entity 105-b may indicate the UE 115-b to use calibration adjustment for UE-side calibration from a previous calibration round.

In some cases, such as for decoupled uplink antenna subset selection (e.g., where the UE 115-b may select separate antenna ports 255 based on evaluating subsets of network entity antenna ports 240 for uplink communication), the network entity 105-b may pre-whiten CSI-RS using Rnn (e.g., or combined Rnn and the calibration adjustment), which may be transparent or not explicitly indicated to the UE 115-b. In such cases, the control information of 305 may indicate that the whitened CSI-RS may be used for uplink computations or selections, and may not be used for downlink computations or selections. In some cases, the network entity 105-b may pre-whiten CSI-RS transmitted on a sub-band using Rnn corresponding to that sub-band (e.g., or combined Rnn corresponding to that sub-band and the calibration adjustment).

Additionally, or alternatively, the control information of 305 may include a decoupled UE antenna subset selection indicator, a joint UE antenna subset selection indicator, or both. For example, decoupled antenna subset selection may include the UE 115-b selecting different subsets 260 of antenna ports 255 for receiving and transmitting communications. Joint antenna subset selection may include the UE 115-b selecting the same subset(s) 260 of antenna ports 255 for receiving and transmitting communications. In some examples, the control information of 305 may indicate one or more weights to combine uplink and downlink metrics computed by the UE 115-b into one composite metric, a range of rank or quantity of layers, or a combination thereof. The range of rank may include a minimum and a maximum rank that the network entity 105-b may assign for downlink, uplink, or both. In some cases, the range of rank or quantity of layers may be common for all sub-configurations or may be separately indicated for one or more sub-configurations (e.g., when the network entity 105-b performs multi-user scheduling).

Additionally, or alternatively, the control information of 305 may indicate one or more subband sets for UE computation of uplink metrics, one or more subband sets for UE computation of downlink metrics, or both. The control information also may indicate transmit power parameters for UE computation. For example, selections for PUCCH or PUSCH may be associated with different anticipated uplink bandwidth allocations and may be computed via different subbands indicated for each sub-configuration indicated for uplink evaluation. In another example, selections for PDCCH or PDSCH may be associated with different anticipated downlink bandwidth allocations and may be computed via different subbands indicated for each sub-configuration indicated for downlink evaluation. In some examples, the network entity 105-b may indicate separate time-offsets for each sub-configuration. The time-offset may be with respect to a known reference time to be used for uplink computations by the UE 115-b. For example, a time-offset may indicate a likely time the UE 115-b may receive an uplink grant. In another example, the control information of 305 may indicate a second time-offset that may indicate a likely time the UE 115-b may receive a downlink grant.

At 310, in some examples, the network entity 105-b may transmit second control information, which may be received by the UE 115-b. In some examples, the second control information of 310 may indicate the calibration adjustment associated with the network entity 105-b, which may be based on the control information of 305 indicating the one or more conditions of the uplink channel between the UE 115-b and the network entity 105-b. For example, the network entity 105-b may indicate the calibration adjustment separately from the Rnn.

At 315, the network entity 105-b may transmit one or more reference signals (e.g., downlink reference signal(s), CSI-RS, via a downlink channel between the UE 115-b and the network entity 105-b, such as a downlink channel 205), which may be received by the UE 115-b. In some examples, the UE 115-b may consider each of the sub-configurations indicated in the control information of 305 and, for each sub-configuration marked as consideration for uplink (e.g., for each of the one or more subsets 245 of network entity antenna ports 240 for uplink evaluation), the UE 115-b may treat ports 240 in the associated subset 245 as receive ports (e.g., of the network entity 105-b). Additionally, or alternatively, the UE 115-b may treat antenna ports 240 in each sub-configuration marked as consideration for downlink (e.g., in each of the one or more subsets bof network entity antenna ports 240 for downlink evaluation) as transmit ports (e.g., of the network entity 105-b).

The UE 115-b may determine a subset of its transmit antennas (e.g., a subset 260 of antenna ports 255) based on a computed uplink metric using the one or more reference signals of 315. For example, the UE 115-b may compute multiple estimates of uplink spectral efficiency that may be achieved using candidate subsets 245 of transmit UE antennas (e.g., transmit ports 255) and network entity receive ports (e.g., receive ports 240). The metric computation may incorporate the transmit power availability as well as other parameters, such as a maximum permissible exposure (MPE) parameter or threshold, indicated power limit or mask, indicated (e.g., in the control information of 305) uplink subband set, and Rnn and calibration adjustment matrices (e.g., if indicated in the control information of 305). Additionally, or alternatively, the UE 115-b may determine a subset of its receive antennas (e.g., a subset 260 of ports 255) based on a computed downlink metric using the one or more reference signals of 315.

For examples in which the network entity 105-b pre-whitens the reference signal(s) of 315 (e.g., CSI-RS) using Rnn (or combined Rnn and network entity-side calibration), the UE 115-b may deduce that the reference signal(s) may be used for uplink computations or selections and may not use the reference signal(s) for downlink-related computations. In some other examples, such as examples in which both decoupled uplink antenna subset selection and joint antenna subset selection are indicated in the control information of 305, the network entity 105-b may indicate Rnn, the calibration adjustment (for network-entity side calibration), combined Rnn and the calibration adjustment (e.g., as full matrix or diagonal elements, for a union of some subsets), or a combination thereof, while no pre-whitening is applied on the reference signal(s) (e.g., CSI-RS) of 315. In such examples, the UE 115-b may apply the indicated Rnn in its uplink metric computation based on the transmit antenna subset selection (e.g., and may not apply the indicated Rnn in its downlink metric computation).

At 320, in some examples, the UE 115-b may determine first CSI for an uplink channel (e.g., an uplink channel 210, between the UE115-b and the network entity 105-b) based on the one or more reference signals of 315 and a first set of one or more time offsets indicated in the control information of 305 (e.g., time-offsets associated with a likely time for an uplink grant). Additionally, or alternatively, the UE 115-b may determine second CSI for the downlink channel (e.g., the downlink channel 205 between the UE 115-b and the network entity 105-b, the downlink channel over which the reference signals of 315 were transmitted) based on the one or more reference signals of 315 and a second set of one or more time offsets indicated in the control information of 305 (e.g., time-offsets associated with a likely time for a downlink grant). For example, the UE 115-b may use a prediction mechanism on the first set of one or more time offsets and the second set of one or more time offsets indicated in the control information of 305 to predict CSI for that likely time based on measurements of the reference signals of 315 (e.g., over a CSI-RS resource set).

In some examples, the UE 115-b may transmit, and the network entity 105-b may receive, a capability report that includes information regarding capability of the UE 115-b to incorporate time offsets to predict CSI. For example, the capability may indicate an achievable mean squared error for predicting a future channel condition or confidence measure in selecting antenna subset based on the predicted future channel condition, for different values of time offsets and/or for different scenarios experienced by the UE 115-b (such as rate of channel variations, channel delay spreads, or the like). In some examples, the network entity 105-b may set the time offsets based on the information regarding this capability of the UE 115-b.

At 325, in some examples, the UE 115-b may determine one or more parameters of the one or more reference signals of 315 for the one or more subsets 245 of network entity antenna ports 240 for uplink evaluation, for the one or more subsets 245 of network entity antenna ports 240 for downlink evaluation, or both. For example, the one or more parameters may include the uplink metric computation, the downlink metric computation, or both. In some examples, the UE 115-b may apply UE-side calibration coefficients in its uplink metric computation in response to receiving the associated indication (e.g., in response to receiving an indication of Rnn, the calibration adjustment, or both in the control information of 305). In some cases, the UE 115-b may use the most recent UE-side calibration coefficients in its uplink metric computation (e.g., as a default, rather than apply the indicated calibration adjustment for the network entity side) unless otherwise indicated in the control information of 305.

At 330, the UE 115-b may select one or more antenna ports 255 based on determining the one or more parameters of the downlink channel for the one or more subsets 245 of network entity antenna ports 240 for uplink evaluation, for the one or more subsets 245 of network entity antenna ports 240 for downlink evaluation, or both. For example, the UE 115-b may select decoupled subsets 260 of antenna ports 255 for its uplink transmission (e.g., transmit antenna subset(s) 260) and subsets of antenna ports 255 for its downlink reception (e.g., receive antenna subset(s) 260). In some other examples, the UE 115-b may select a common subset 260 of antenna ports 255 based on both uplink (transmission) and downlink (reception). In some examples, the UE 115-b may determine one or more uplink antenna subsets 260, one or more downlink antenna subsets 260, or both, using the respective predicted CSI determined at 320. For example, the UE 115-b may select one or more transmit antenna subsets 260 using the first CSI and the UE 115-b may select one or more receive antenna subsets 260 using the second CSI.

Additionally, or alternatively, the UE 115-b may select the one or more antenna ports 255 from multiple antenna ports 255 of the UE 115-b (e.g., from an antenna panel or antenna array of the UE 115-b, such as an antenna array 250) based on a spectral efficiency associated with the uplink channel, a transmission power availability, a MPE parameter, an uplink subband set, or a combination thereof. In some cases, the one or more antenna ports 255 may be associated with the one or more subsets 245 of network entity antenna ports 240 for uplink evaluation. For example, the UE 115-b may select the one or more antenna ports 255 based on computing the estimates of uplink spectral efficiency that may be achieved using the one or more subsets 245 (e.g., the UE 115-b may select antenna ports 255 that may achieve a relatively highest estimated spectral efficiency). In some other examples, the UE 115-b may select the one or more antenna ports 255 from the multiple antenna ports 255 of the UE 115-b based on the control information of 305 indicating the one or more subsets 245 of network entity antenna ports 240 for uplink evaluation, the one or more subsets 245 of network entity antenna ports 240 for downlink evaluation, or both. The selection of the one or more antenna ports 255 by the UE 115-b associated with the one or more subsets 245 may reduce signaling overhead and increase network energy savings because the UE 115-b may select antenna ports associated with relatively higher estimated spectral efficiencies and inform the network entity about energy efficient subset choices.

At 335, in some examples, the UE 115-b may transmit a selection indication, which may be received by the network entity 105-b. The selection indication of 335 may include an indication of a quantity of the one or more antenna ports 255 for the one or more subsets 245 of network entity antenna ports 240 for uplink evaluation, downlink evaluation, or both. For example, the UE 115-b may indicate how many uplink antenna ports 255 were selected for each sub-configuration marked as decoupled-uplink selection or for joint selection (e.g., where both uplink and downlink antenna ports 255 may be the same). The UE 115-b may also indicate a composition of the selected one or more antenna ports 255, such as which antenna ports 255 were selected for each sub-configuration. That is, the UE 115-b may indicate an identifier of the one or more antenna ports 255 for the one or more subsets 245 of network entity antenna ports 240 for uplink evaluation, downlink evaluation, or both. Additionally, or alternatively, the UE 115-b may indicate one or more computed parameters of the uplink channel or the downlink channel, such as the uplink metric computation, the downlink metric computation, or both.

In some other examples, the UE 115-b may indicate a quantity of the one or more antenna ports 255 selected for a portion of the one or more subsets 245 of network entity antenna ports 240 for uplink evaluation, downlink evaluation, or both. For example, the UE 115-b may indicate a quantity of uplink antenna ports 255 selected for a top k quantity of sub-configurations (e.g., where k may be indicated in the control information of 305). In some cases, the UE 115-b may indicate an identifier of the one or more antenna ports 255 for each subset 245 in the portion (e.g., in the top k sub-configurations) of the one or more subsets 245 of network entity antenna ports 240 for uplink evaluation, downlink evaluation, or both. Additionally, or alternatively, the UE 115-b may indicate a union of all distinct selected ports 255 across all sub-configurations or across the top k sub-configurations. In some examples, the UE 115-b may transmit the indication via UCI, via a MAC control element (MAC-CE), in response to an event-trigger (e.g., a timer duration expiration, a completion of the uplink or downlink metric computation, a request from the network entity 105-b), or a combination thereof. In some examples, indicating the selected quantity of the one or more antenna ports 255 for a top k quantity of sub-configurations may increase network energy savings because the network entity 105-b may know a quantity (e.g., minimum quantity) of antenna ports 240 to use for communications with the UE 115-b.

At 340, in some examples, the network entity 105-b may transmit a feedback message based on the selection indication of 335, which may be received by the UE 115-b. The network entity 105-b may transmit the feedback message to acknowledge reception of the selection indication of 335 from the UE 115-b. The feedback message may indicate a selected sub-configuration (e.g., hypothesis or subset 245 of network entity antenna ports 240) associated with the network entity receive antenna ports 240. In some examples, uplink reference signal control information, uplink grant information, or both, may be based on the feedback message of 340. For example, the UE 115-b may determine the uplink reference signal control information (e.g., SRS configuration information for SRS transmission) based on the feedback message of 340. That is, the UE 115-b may infer the uplink subset 260 that it selected for the sub-configuration indicated in the feedback message of 340 and may determine the quantity of sounding ports 255. Additionally, or alternatively, the UE 115-b may determine the uplink grant (e.g., size of a transmit precoding matrix indicator (TPMI) or scheduling request information (SRI) in uplink DCI) based on the feedback message of 340. In such examples, the UE indication of the selected one or more antenna subsets 260 (e.g., of the selection indication of 335) may be assumed to be “sticky” with a slower cadence relative to dynamic uplink scheduling.

At 345, the UE 115-b may communicate with the network entity 105-b using the one or more antenna ports 255 selected by the UE 115-b (e.g., in response to the UE 115-b receiving the control information of 305 and the one or more downlink reference signals of 315). In some examples, the UE 115-b communicating with the network entity 105-b may be further in response to the UE 115-b receiving the second control information of 310.

In some examples, at 350, the communication between the network entity 105-b and the UE 115-b may include uplink communication (e.g., transmission of uplink communication by the UE 115-b) using a first subset 260 of antenna ports 255 of the UE 115-b, which may be received by the network entity 105-b. The one or more antenna ports 255 for such uplink communication may include the first subset 260 of antenna ports 255. The first subset 260 of antenna ports 255 may be based on determining first CSI at 320. Additionally, or alternatively, at 355, the communication between the network entity 105-b and the UE 115-b may include downlink communication (e.g., reception of downlink communication by the UE 115-b) using a second subset 260 of antenna ports 255 of the UE 115-b, which may be transmitted by the network entity 105-b. The one or more antenna ports 255 for such downlink communication may include the second subset 260 of antenna ports 255. The second subset 260 of antenna ports 255 may be based on determining second CSI at 320. In some examples, the first subset 260 of antenna ports 255 may be the same as the second subset 260 of antenna ports 255 based on receiving the one or more reference signals of 315, or may be different.

By enabling the UE 115-b to select the one or more subsets 260 of antenna ports 255 for communication, the described techniques can be used to reduce signaling overhead (e.g., selection may be based on downlink reference signals rather than a combination of uplink and downlink reference signals). Additionally, by selecting and reporting the one or more subsets 260 of antenna ports 255 based on the one or more hypotheses indicated in the control information of 305, the described techniques can be used to increase network energy savings because the network entity 105-b may know a minimum quantity of antenna ports 240 to use to communicate with the UE 115-b.

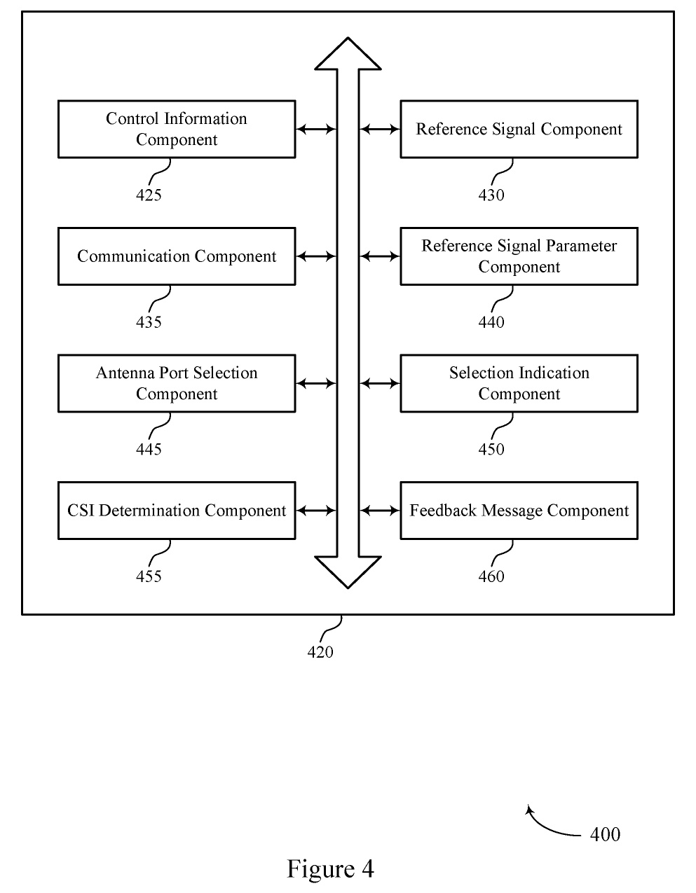

FIG. 4 shows an example of a processing system 420 that supports signaling for UE antenna subset selection. A processing system 420 may be an example of a processing system 140 (such as of a UE 115) and may include a control information component 425, a reference signal component 430, a communication component 435, a reference signal parameter component 440, an antenna port selection component 445, a selection indication component 450, a CSI determination component 455, a feedback message component 460, or any combination thereof. A processing system 420, or various component thereof, may be an example of means for performing (such as a means for causing a UE 115 to perform) various techniques described herein.

The control information component 425 may be configured to cause the UE 115 to receive, at the UE, control information indicating one or more conditions of an uplink channel between the UE and a network entity, a calibration adjustment associated with the network entity, one or more subsets of network entity antenna ports for uplink evaluation, or one or more subsets of network entity antenna ports for downlink evaluation, or a combination thereof. The reference signal component 430 may be configured to cause the UE 115 to receive, at the UE, one or more downlink reference signals via a downlink channel between the UE and the network entity. The communication component 435 may be configured to cause the UE 115 to communicate, at the UE, with the network entity using one or more antenna ports selected by the UE in response to receiving the control information and the one or more downlink reference signals.

In some examples, to support communicating with the network entity using the one or more antenna ports, the communication component 435 may be configured to cause the UE 115 to transmit uplink communication using a first subset of antenna ports of a set of multiple antenna ports of the UE, the one or more antenna ports including the first subset of antenna ports. In some examples, to support communicating with the network entity using the one or more antenna ports, the communication component 435 may be configured to cause the UE 115 to receive downlink communication using a second subset of antenna ports of the set of multiple antenna ports of the UE, the one or more antenna ports including the second subset of antenna ports. In some examples, the first subset of antenna ports is the same as the second subset of antenna ports based on receiving the one or more downlink reference signals.

In some examples, the CSI determination component 455 may be configured to cause the UE 115 to determine first channel state information for the uplink channel based on the one or more downlink reference signals and a first set of one or more time offsets indicated in the control information, where the first subset of the one or more antenna ports is based on determining the first channel state information. In some examples, the CSI determination component 455 may be configured to cause the UE 115 to determine second channel state information for the downlink channel based on the one or more downlink reference signals and a second set of one or more time offsets indicated in the control information, where the second subset of the one or more antenna ports is based on determining the second channel state information.

In some examples, the control information component 425 may be configured to cause the UE 115 to receive second control information indicating the calibration adjustment associated with the network entity based on the control information indicating the one or more conditions of the uplink channel between the UE and the network entity, where communicating with the network entity is further in response to receiving the second control information.

In some examples, the reference signal parameter component 440 may be configured to cause the UE 115 to determine one or more parameters of the one or more downlink reference signals for the one or more subsets of network entity antenna ports for uplink evaluation, for the one or more subsets of network entity antenna ports for downlink evaluation, or both. In some examples, the antenna port selection component 445 may be configured to cause the UE 115 to select the one or more antenna ports based on determining the one or more parameters of the downlink channel for the one or more subsets of network entity antenna ports for uplink evaluation, for the one or more subsets of network entity antenna ports for downlink evaluation, or both.

In some examples, the antenna port selection component 445 may be configured to cause the UE 115 to select the one or more antenna ports from a set of multiple antenna ports of the UE, the selection of the one or more antenna ports based on a spectral efficiency associated with the uplink channel, a transmission power availability, an MPE parameter, an uplink subband set, or a combination thereof, and where the one or more antenna ports are associated with the one or more subsets of network entity antenna ports for uplink evaluation.

In some examples, the antenna port selection component 445 may be configured to cause the UE 115 to select the one or more antenna ports from a set of multiple antenna ports based on the control information indicating the one or more subsets of network entity antenna ports for uplink evaluation, the one or more subsets of network entity antenna ports for downlink evaluation, or both. In some examples, the selection indication component 450 may be configured to cause the UE 115 to transmit an indication of a quantity of the one or more antenna ports for the one or more subsets of network entity antenna ports for uplink evaluation, downlink evaluation, or both, one or more computed parameters of the uplink channel or the downlink channel, a quantity of the one or more antenna ports selected for a portion of the one or more subsets of network entity antenna ports for uplink evaluation, downlink evaluation, or both, an identifier of the one or more antenna ports for the one or more subsets of network entity antenna ports for uplink evaluation, downlink evaluation, or both, an identifier of the one or more antenna ports for each subset in the portion of the one or more subsets of network entity antenna ports for uplink evaluation, downlink evaluation, or both, or a combination thereof.

In some examples, the one or more subsets of network entity antenna ports for uplink evaluation, downlink evaluation, or both, are defined based on a common reference signal resource set or defined based on a set of multiple reference signal resources. In some examples, the feedback message component 460 may be configured to cause the UE 115 to receive a feedback message based on transmitting the indication, where uplink reference signal control information, uplink grant information, or both is based on receiving the feedback message.

In some examples, the one or more downlink reference signals are one or more channel state information reference signals and the uplink reference signal control information is sounding reference signal control information. In some examples, the indication is transmitted via uplink control information, via a MAC-CE, in response to an event trigger, or a combination thereof.

In some examples, the one or more conditions of the uplink channel between the UE and the network entity includes a noise plus interference covariance matrix. In some examples, the control information indicates the one or more conditions of the uplink channel between the UE and the network entity. In some examples, the one or more conditions of the uplink channel are determined based on the calibration adjustment.

In some examples, the control information further indicates a set of multiple network entity antenna ports, a UE antenna subset selection parameter, one or more weights associated with the one or more conditions of the uplink channel or with one or more conditions of the downlink channel, a range of ranks associated with the downlink channel or with the uplink channel, a quantity of layers associated with the downlink channel or with the uplink channel, one or more subband sets associated with the uplink channel or with the downlink channel, one or more power parameters associated with the uplink channel, a pre-whitened reference signal parameter, one or more time offsets associated with the one or more subsets of network entity antenna ports for uplink evaluation, downlink evaluation, or both, or a combination thereof.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

By including or configuring a processing system 420 for operation in a processing system 420 as described herein, the processing system 420 may support techniques for reduced processing, reduced power consumption, and more efficient utilization of communication resources, among other examples (e.g., because a UE may select the one or more subsets of antenna ports based on the one or more downlink reference signals).

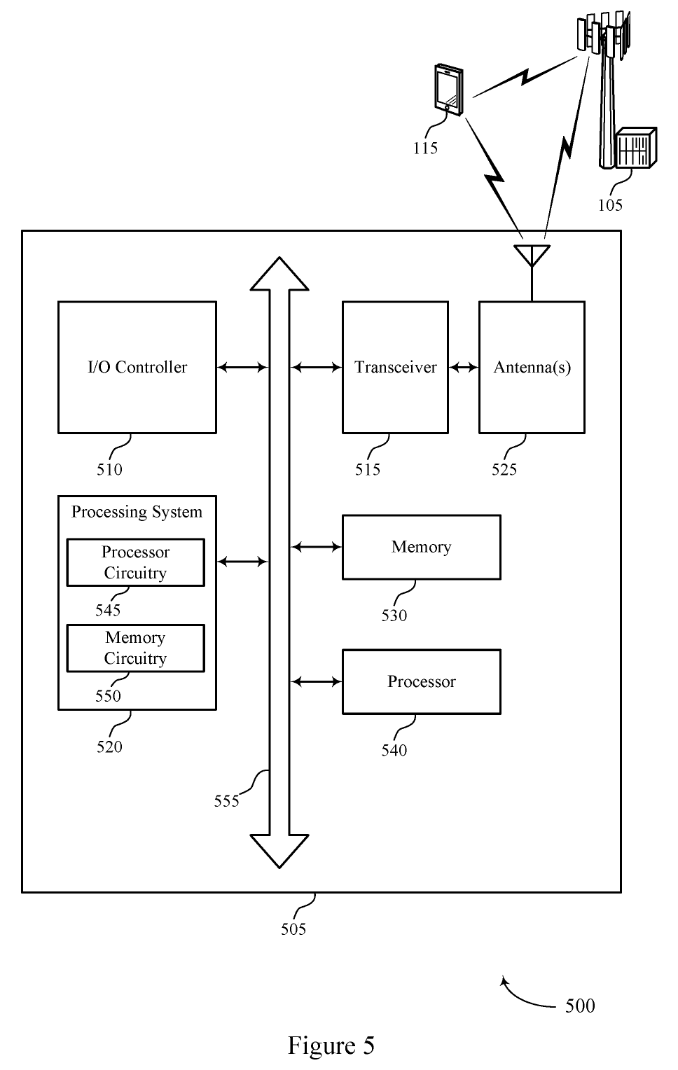

FIG. 5 shows an example of a system 500 including a device 505 that supports signaling for UE antenna subset selection. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 400. For example, the processing system 520 may include processor circuitry 545 and memory circuitry 550 that stores code, and may be configured to cause the device 505 to perform operations that support signaling for UE antenna subset selection. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, may support techniques for improved communication reliability, reduced latency, more efficient utilization of communication resources (e.g., the network entity may have a better understanding of which antenna ports to use for communications with the UE based on the UE indicating the antenna port selection), improved coordination between devices, among other examples.

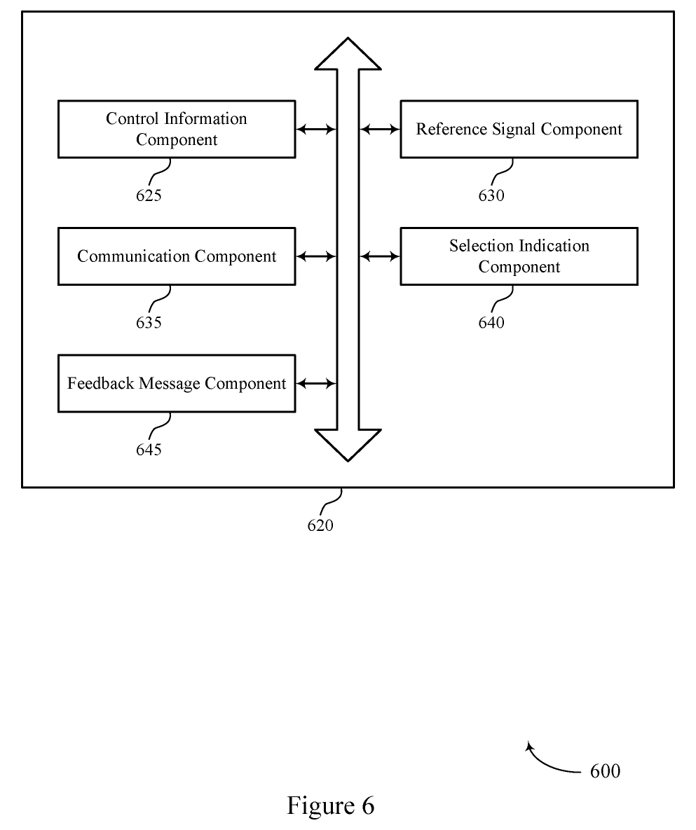

FIG. 6 shows an example of a processing system 620 that supports signaling for UE antenna subset selection. A processing system 620 may be an example of a processing system 145 (such as network entity 105) and may include a control information component 625, a reference signal component 630, a communication component 635, a selection indication component 640, a feedback message component 645, or any combination thereof. A processing system 620, or various component thereof, may be an example of means for performing (such as a means for causing a network entity 105 to perform) various techniques described herein.

The control information component 625 may be configured to cause the network entity 105 to transmit, from the network entity, control information indicating one or more conditions of an uplink channel between a UE and the network entity, a calibration adjustment associated with the network entity, one or more subsets of network entity antenna ports for uplink evaluation, or one or more subsets of network entity antenna ports for downlink evaluation, or a combination thereof. The reference signal component 630 may be configured to cause the network entity 105 to transmit, from the network entity, one or more downlink reference signals via a downlink channel between the UE and the network entity. The communication component 635 may be configured to cause the network entity 105 to communicate, at the network entity, with the UE in response to transmitting the control information and the one or more downlink reference signals.

In some examples, to support communicating with the UE, the communication component 635 may be configured to cause the network entity 105 to receive uplink communication associated with a first subset of antenna ports of a set of multiple antenna ports of the UE. In some examples, to support communicating with the UE, the communication component 635 may be configured to cause the network entity 105 to transmit downlink communication associated with a second subset of antenna ports of the set of multiple antenna ports of the UE. In some examples, the first subset of antenna ports is the same as the second subset of antenna ports based on transmitting the one or more downlink reference signals.

In some examples, the control information component 625 may be configured to cause the network entity 105 to transmit second control information indicating the calibration adjustment associated with the network entity based on the control information indicating the one or more conditions of the uplink channel between the UE and the network entity, where communicating with the UE is further in response to transmitting the second control information. In some examples, the one or more subsets of network entity antenna ports for uplink evaluation, downlink evaluation, or both, are defined based on a common reference signal resource set or defined based on a set of multiple reference signal resources.

In some examples, the selection indication component 640 may be configured to cause the network entity 105 to receive an indication of a quantity of antenna ports of the UE associated with the one or more subsets of network entity antenna ports for uplink evaluation, downlink evaluation, or both, one or more computed parameters of the uplink channel or the downlink channel, a quantity of antenna ports of the UE associated with a portion of the one or more subsets of network entity antenna ports for uplink evaluation, downlink evaluation, or both, an identifier of the antenna ports of the UE for the one or more subsets of network entity antenna ports for uplink evaluation, downlink evaluation, or both, an identifier of the antenna ports of the UE for each subset in the portion of the one or more subsets of network entity antenna ports for uplink evaluation, downlink evaluation, or both, or a combination thereof.

In some examples, the feedback message component 645 may be configured to cause the network entity 105 to transmit a feedback message based on receiving the indication, where uplink reference signal control information, uplink grant information, or both, is based on transmitting the feedback message. In some examples, the one or more downlink reference signals are one or more channel state information reference signals and the uplink reference signal control information is sounding reference signal control information.

In some examples, the indication is received via uplink control information, via a MAC-CE, in response to an event trigger, or a combination thereof. In some examples, the one or more conditions of the uplink channel between the UE and the network entity includes a noise plus interference covariance matrix. In some examples, the control information indicates the one or more conditions of the uplink channel between the UE and the network entity. In some examples, the one or more conditions of the uplink channel are determined based on the calibration adjustment.

In some examples, the control information further indicates a set of multiple network entity antenna ports, a UE antenna subset selection parameter, one or more weights associated with the one or more conditions of the uplink channel or with one or more conditions of the downlink channel, a range of ranks associated with the downlink channel or with the uplink channel, a quantity of layers associated with the downlink channel or with the uplink channel, one or more subband sets associated with the uplink channel or with the downlink channel, one or more power parameters associated with the uplink channel, a pre-whitened reference signal parameter, one or more time offsets associated with the one or more subsets of network entity antenna ports for uplink evaluation, downlink evaluation, or both, or a combination thereof.

A processing system 620 may include or be an example of one or more chips, SoCs, chipsets, packages, components, or devices that individually or collectively constitute or include a processing system. A processing system 620 may interface with other components of a network entity 105. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a network entity 105). Operations described herein with reference to the processing system 620, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 620 for operation in a processing system 620 as described herein, the processing system 620 may support techniques for reduced processing and more efficient utilization of communication resources, among other examples.

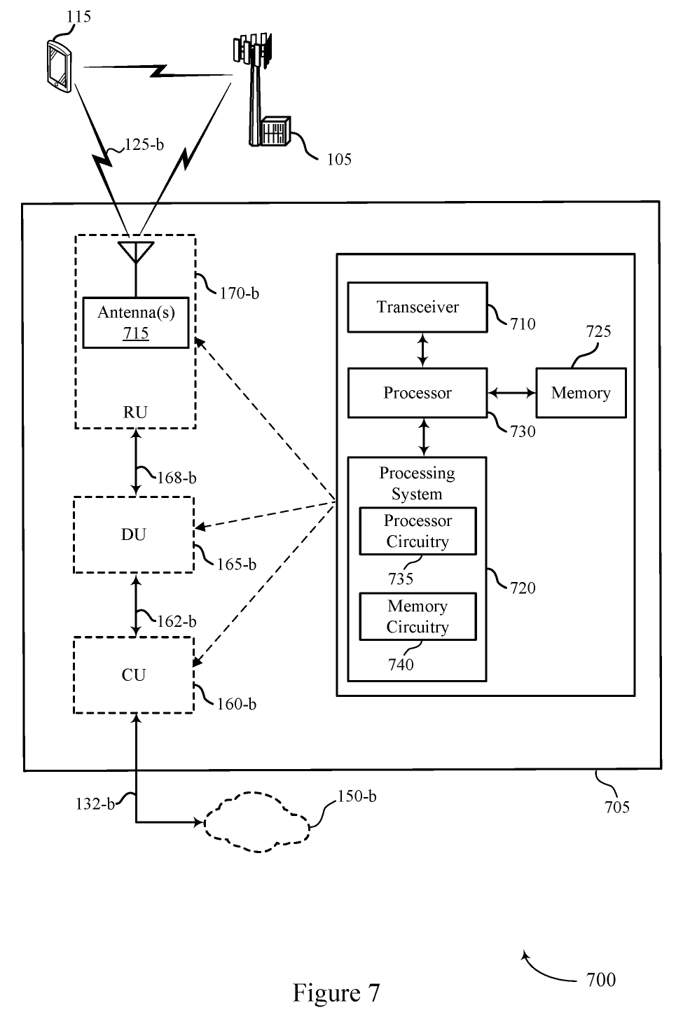

FIG. 7 shows an example of a system 700 including a device 705 that supports signaling for UE antenna subset selection. The device 705 may communicate (such as via one or more wired interfaces or one or more wireless interfaces) with other network devices or network equipment such as a core network 150-b, other network entities 105, UEs 115, or any combination thereof. The device 705 may include components for transmitting and receiving communication, which may include a processing system 720, a transceiver 710, antenna(s) 715, a memory 725, and a processor 730. Components of the device 705 may be coupled (such as operatively, communicatively, functionally, electronically, electrically, in electronic communication) via one or more interfaces.

The transceiver 710 may communicate bi-directionally with another transceiver via wired or wireless links, and may support transmission operations, reception operations, or both, as described herein. The transceiver 710 may include a modem to modulate and demodulate signals, to provide the modulated signals for transmission (such as via antenna(s) 715, via a wired interface), and to demodulate received signals (such as received via antenna(s) 715, received via a wired interface). The transceiver 710 may be operable to support communication via one or more communication links (such as a communication link 125-b, a backhaul link 132-b, a midhaul link 162-b, fronthaul link 168-b).

The processor 730 may be a general-purpose processing component that supports various operations (such as applications) of the device 705. The memory 725 may be a general-purpose storage component that stores code executable by the processor 730. Such code may include instructions that, when executed by the processor 730, cause the device 705 to perform various functions (such as to support an application of the device 705).

For examples in which the device 705 is a network entity 105 in a disaggregated architecture, one or more components of the device 705 may be located at one or more of a CU 160-b, a DU 165-b, or an RU 170-b, one or more of which may include aspects of the processing system 720, the processor 730, the memory 725, or the transceiver 710. Functions of the device 705 may be performed at different components or an operation may be divided between different components (such as different functions being supported by aspects of the CU 160-b, the DU 165-b, or the RU 170-b, the transceiver 710, the processor 730, the memory 725, the processing system 720, or any combination thereof). For example, the processing system 720 may be a component of one or more of the CU 160-b, the DU 165-b, or the RU 170-b. In some examples, interfaces between components of device 705 (such as CU 160-b, DU 165-b, RU 170-b) may support communication at a protocol layer or between protocol layers of a protocol stack.

In some examples, the processing system 720 may manage aspects of communication with the core network 150-b (such as via a backhaul link 132). For example, the processing system 720 may manage the transfer of data communication for UEs 115 with a gateway of the core network 150-b. In some examples, the processing system 720 may manage communication with one or more other network entities 105 and may include a controller or scheduler for controlling communication with UEs 115 (such as in cooperation with the one or more other network entities 105). In some examples, the processing system 720 may support an interface (such as X2 interface, Xn interface) to provide communication between network entities 105.

The processing system 720 may be an example of a processing system 145 or a processing system 600. For example, the processing system 720 may include processor circuitry 735 and memory circuitry 740 that stores code, and the processing system 720 may be configured to cause the device 705 to perform operations that support signaling for UE antenna subset selection. Although the processing system 720 is illustrated as a separate component, which may involve a separate chip, chipset, or other module, in some implementations, one or more functions described with reference to the processing system 720 may be supported by or performed by a transceiver 710, antenna(s) 715, a processor 730, memory 725, or any combination thereof, such that a processing system 720 may include one or more of a transceiver 710, antenna(s) 715, a processor 730, memory 725, or any combination thereof. Further, processor circuitry 735 and memory circuitry 740 each may be implemented at the device 705 in accordance with an aggregated architecture, or the processor circuitry 735 and the memory circuitry 740 may be implemented at one or more of a CU 160-b, a DU 165-b, or an RU 170-b in accordance with a disaggregated architecture.

By including or configuring the processing system 720 for operation in the device 705 as described herein, may support techniques for improved communication reliability, reduced latency, more efficient utilization of communication resources, and improved coordination between devices, among other examples.

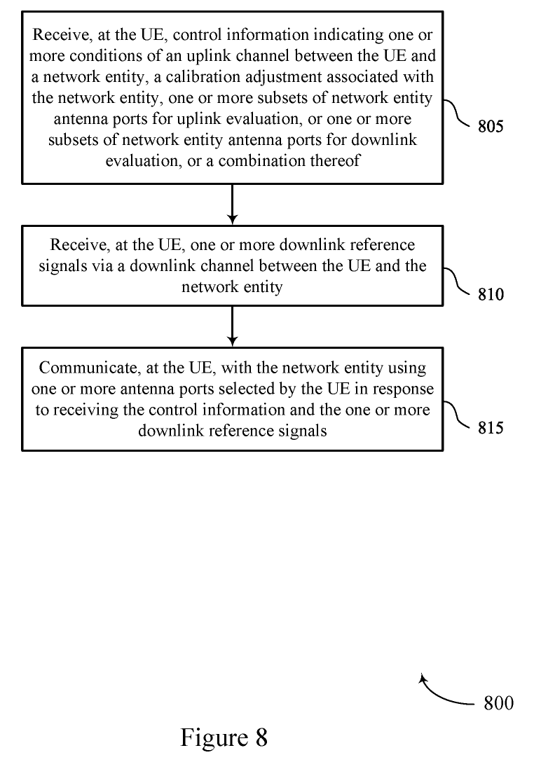

FIG. 8 shows an example of a method 800 that supports signaling for UE antenna subset selection. Operations of the method 800 may be performed by a UE or its components (such as using a processing system configured to cause the UE 115 to perform one or more of the operations) as described herein.

At 805, the method may include receiving, at the UE, control information indicating one or more conditions of an uplink channel between the UE and a network entity, a calibration adjustment associated with the network entity, one or more subsets of network entity antenna ports for uplink evaluation, or one or more subsets of network entity antenna ports for downlink evaluation, or a combination thereof. In some examples, aspects of the operations of 805 may be performed by a control information component 425.

At 810, the method may include receiving, at the UE, one or more downlink reference signals via a downlink channel between the UE and the network entity. In some examples, aspects of the operations of 810 may be performed by a reference signal component 430.

At 815, the method may include communicating, at the UE, with the network entity using one or more antenna ports selected by the UE in response to receiving the control information and the one or more downlink reference signals. In some examples, aspects of the operations of 815 may be performed by a communication component 435.

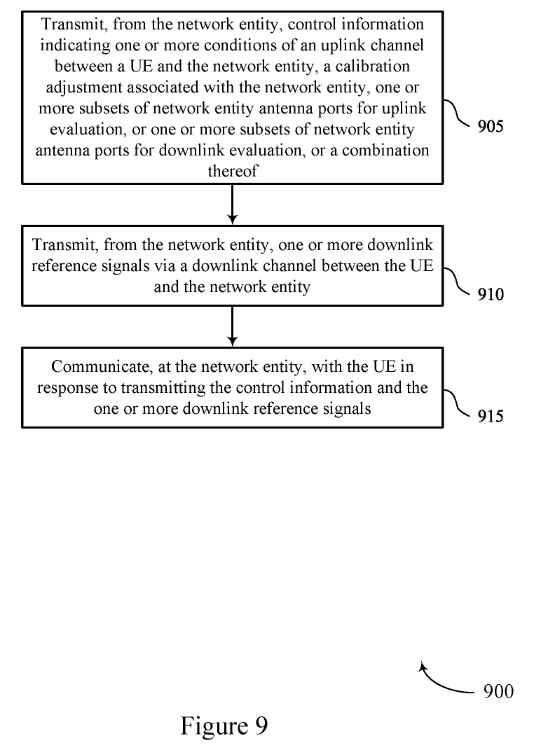

FIG. 9 shows an example of a method 900 that supports signaling for UE antenna subset selection. Operations of the method 900 may be performed by a network entity 105 or its components (such as using a processing system configured to cause the network entity to perform one or more operations) as described herein.

At 905, the method may include transmitting, from the network entity, control information indicating one or more conditions of an uplink channel between a UE and the network entity, a calibration adjustment associated with the network entity, one or more subsets of network entity antenna ports for uplink evaluation, or one or more subsets of network entity antenna ports for downlink evaluation, or a combination thereof. In some examples, aspects of the operations of 905 may be performed by a control information component 625.

At 910, the method may include transmitting, from the network entity, one or more downlink reference signals via a downlink channel between the UE and the network entity. In some examples, aspects of the operations of 910 may be performed by a reference signal component 630.

At 915, the method may include communicating, at the network entity, with the UE in response to transmitting the control information and the one or more downlink reference signals. In some examples, aspects of the operations of 915 may be performed by a communication component 635.

Implementation examples are described in the following numbered clauses:

Aspect 1: A method for wireless communications at a UE, including: receiving, at the UE, control information indicating one or more conditions of an uplink channel between the UE and a network entity, a calibration adjustment associated with the network entity, one or more subsets of network entity antenna ports for uplink evaluation, or one or more subsets of network entity antenna ports for downlink evaluation, or a combination thereof; receiving, at the UE, one or more downlink reference signals via a downlink channel between the UE and the network entity; and communicating, at the UE, with the network entity using one or more antenna ports selected by the UE in response to receiving the control information and the one or more downlink reference signals.

Aspect 2: The method of aspect 1, where communicating with the network entity using the one or more antenna ports includes: transmitting uplink communication using a first subset of antenna ports of a set of multiple antenna ports of the UE, the one or more antenna ports including the first subset of antenna ports; or receiving downlink communication using a second subset of antenna ports of the set of multiple antenna ports of the UE, the one or more antenna ports including the second subset of antenna ports.

Aspect 3: The method of aspect 2, where the first subset of antenna ports is the same as the second subset of antenna ports based on receiving the one or more downlink reference signals.

Aspect 4: The method of any of aspects 2 through 3, further including: determining first channel state information for the uplink channel based on the one or more downlink reference signals and a first set of one or more time offsets indicated in the control information, where the first subset of the one or more antenna ports is based on determining the first channel state information; or determining second channel state information for the downlink channel based on the one or more downlink reference signals and a second set of one or more time offsets indicated in the control information, where the second subset of the one or more antenna ports is based on determining the second channel state information.

Aspect 5: The method of any of aspects 1 through 4, further including: receiving second control information indicating the calibration adjustment associated with the network entity based on the control information indicating the one or more conditions of the uplink channel between the UE and the network entity, where communicating with the network entity is further in response to receiving the second control information.

Aspect 6: The method of any of aspects 1 through 5, further including: determining one or more parameters of the one or more downlink reference signals for the one or more subsets of network entity antenna ports for uplink evaluation, for the one or more subsets of network entity antenna ports for downlink evaluation, or both; and selecting the one or more antenna ports based on determining the one or more parameters of the downlink channel for the one or more subsets of network entity antenna ports for uplink evaluation, for the one or more subsets of network entity antenna ports for downlink evaluation, or both.

Aspect 7: The method of any of aspects 1 through 6, further including: selecting the one or more antenna ports from a set of multiple antenna ports of the UE, the selection of the one or more antenna ports based on a spectral efficiency associated with the uplink channel, a transmission power availability, an MPE parameter, an uplink subband set, or a combination thereof, and where the one or more antenna ports are associated with the one or more subsets of network entity antenna ports for uplink evaluation.

Aspect 8: The method of any of aspects 1 through 7, further including: selecting the one or more antenna ports from a set of multiple antenna ports based on the control information indicating the one or more subsets of network entity antenna ports for uplink evaluation, the one or more subsets of network entity antenna ports for downlink evaluation, or both; and transmitting an indication of a quantity of the one or more antenna ports for the one or more subsets of network entity antenna ports for uplink evaluation, downlink evaluation, or both, one or more computed parameters of the uplink channel or the downlink channel, a quantity of the one or more antenna ports selected for a portion of the one or more subsets of network entity antenna ports for uplink evaluation, downlink evaluation, or both, an identifier of the one or more antenna ports for the one or more subsets of network entity antenna ports for uplink evaluation, downlink evaluation, or both, an identifier of the one or more antenna ports for each subset in the portion of the one or more subsets of network entity antenna ports for uplink evaluation, downlink evaluation, or both, or a combination thereof.

Aspect 9: The method of aspect 8, where the one or more subsets of network entity antenna ports for uplink evaluation, downlink evaluation, or both, are defined based on a common reference signal resource set or defined based on a set of multiple reference signal resources.

Aspect 10: The method of any of aspects 8 through 9, further including: receiving a feedback message based on transmitting the indication, where uplink reference signal control information, uplink grant information, or both is based on receiving the feedback message.

Aspect 11: The method of aspect 10, where the one or more downlink reference signals are one or more channel state information reference signals and the uplink reference signal control information is sounding reference signal control information.

Aspect 12: The method of any of aspects 8 through 11, where the indication is transmitted via uplink control information, via a MAC-CE, in response to an event trigger, or a combination thereof.

Aspect 13: The method of any of aspects 1 through 12, where the one or more conditions of the uplink channel between the UE and the network entity includes a noise plus interference covariance matrix.

Aspect 14: The method of any of aspects 1 through 13, where the control information indicates the one or more conditions of the uplink channel between the UE and the network entity, and the one or more conditions of the uplink channel are determined based on the calibration adjustment.

Aspect 15: The method of any of aspects 1 through 14, where the control information further indicates a set of multiple network entity antenna ports, a UE antenna subset selection parameter, one or more weights associated with the one or more conditions of the uplink channel or with one or more conditions of the downlink channel, a range of ranks associated with the downlink channel or with the uplink channel, a quantity of layers associated with the downlink channel or with the uplink channel, one or more subband sets associated with the uplink channel or with the downlink channel, one or more power parameters associated with the uplink channel, a pre-whitened reference signal parameter, one or more time offsets associated with the one or more subsets of network entity antenna ports for uplink evaluation, downlink evaluation, or both, or a combination thereof.

Aspect 16: A method for wireless communications at a network entity, including: transmitting, from the network entity, control information indicating one or more conditions of an uplink channel between a UE and the network entity, a calibration adjustment associated with the network entity, one or more subsets of network entity antenna ports for uplink evaluation, or one or more subsets of network entity antenna ports for downlink evaluation, or a combination thereof; transmitting, from the network entity, one or more downlink reference signals via a downlink channel between the UE and the network entity; and communicating, at the network entity, with the UE in response to transmitting the control information and the one or more downlink reference signals.

Aspect 17: The method of aspect 16, where communicating with the UE includes: receiving uplink communication associated with a first subset of antenna ports of a set of multiple antenna ports of the UE; or transmitting downlink communication associated with a second subset of antenna ports of the set of multiple antenna ports of the UE.

Aspect 18: The method of aspect 17, where the first subset of antenna ports is the same as the second subset of antenna ports based on transmitting the one or more downlink reference signals.

Aspect 19: The method of any of aspects 16 through 18, further including: transmitting second control information indicating the calibration adjustment associated with the network entity based on the control information indicating the one or more conditions of the uplink channel between the UE and the network entity, where communicating with the UE is further in response to transmitting the second control information.

Aspect 20: The method of any of aspects 16 through 19, where the one or more subsets of network entity antenna ports for uplink evaluation, downlink evaluation, or both, are defined based on a common reference signal resource set or defined based on a set of multiple reference signal resources.

Aspect 21: The method of any of aspects 16 through 20, further including: receiving an indication of a quantity of antenna ports of the UE associated with the one or more subsets of network entity antenna ports for uplink evaluation, downlink evaluation, or both, one or more computed parameters of the uplink channel or the downlink channel, a quantity of antenna ports of the UE associated with a portion of the one or more subsets of network entity antenna ports for uplink evaluation, downlink evaluation, or both, an identifier of the antenna ports of the UE for the one or more subsets of network entity antenna ports for uplink evaluation, downlink evaluation, or both, an identifier of the antenna ports of the UE for each subset in the portion of the one or more subsets of network entity antenna ports for uplink evaluation, downlink evaluation, or both, or a combination thereof.

Aspect 22: The method of aspect 21, further including: transmitting a feedback message based on receiving the indication, where uplink reference signal control information, uplink grant information, or both, is based on transmitting the feedback message.

Aspect 23: The method of aspect 22, where the one or more downlink reference signals are one or more channel state information reference signals and the uplink reference signal control information is sounding reference signal control information.

Aspect 24: The method of any of aspects 21 through 23, where the indication is received via uplink control information, via a MAC-CE, in response to an event trigger, or a combination thereof.

Aspect 25: The method of any of aspects 16 through 24, where the one or more conditions of the uplink channel between the UE and the network entity includes a noise plus interference covariance matrix.

Aspect 26: The method of any of aspects 16 through 25, where the control information indicates the one or more conditions of the uplink channel between the UE and the network entity, and the one or more conditions of the uplink channel are determined based on the calibration adjustment.

Aspect 27: The method of any of aspects 16 through 26, where the control information further indicates a set of multiple network entity antenna ports, a UE antenna subset selection parameter, one or more weights associated with the one or more conditions of the uplink channel or with one or more conditions of the downlink channel, a range of ranks associated with the downlink channel or with the uplink channel, a quantity of layers associated with the downlink channel or with the uplink channel, one or more subband sets associated with the uplink channel or with the downlink channel, one or more power parameters associated with the uplink channel, a pre-whitened reference signal parameter, one or more time offsets associated with the one or more subsets of network entity antenna ports for uplink evaluation, downlink evaluation, or both, or a combination thereof.

Aspect 28: A UE for wireless communications, comprising a processing system that includes processor circuitry and memory circuitry that stores code, the processing system configured to cause the UE to perform a method of any of aspects 1 through 15.

Aspect 29: A UE for wireless communications, comprising at least one means for performing a method of any of aspects 1 through 15.

Aspect 30: A non-transitory computer-readable medium storing code for wireless communications, the code comprising instructions executable by one or more processors to perform a method of any of aspects 1 through 15.

Aspect 31: A network entity for wireless communications, comprising a processing system that includes processor circuitry and memory circuitry that stores code, the processing system configured to cause the network entity to perform a method of any of aspects 16 through 27.

Aspect 32: A network entity for wireless communications, comprising at least one means for performing a method of any of aspects 16 through 27.

Aspect 33: A non-transitory computer-readable medium storing code for wireless communications, the code comprising instructions executable by one or more processors to perform a method of any of aspects 16 through 27.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive, at the UE, control information indicating one or more conditions of an uplink channel between the UE and a network entity, a calibration adjustment associated with the network entity, one or more subsets of network entity antenna ports for uplink evaluation, or one or more subsets of network entity antenna ports for downlink evaluation, or a combination thereof;
receive, at the UE, one or more downlink reference signals via a downlink channel between the UE and the network entity; and
communicate, at the UE, with the network entity using one or more antenna ports selected by the UE in response to the control information and the one or more downlink reference signals.

2. The UE of claim 1, wherein, to communicate with the network entity using the one or more antenna ports, the processing system is configured to cause the UE to:
transmit uplink communication using a first subset of antenna ports of a plurality of antenna ports of the UE, the one or more antenna ports comprising the first subset of antenna ports; or
receive downlink communication using a second subset of antenna ports of the plurality of antenna ports of the UE, the one or more antenna ports comprising the second subset of antenna ports.

3. The UE of claim 2, wherein the first subset of antenna ports is the same as the second subset of antenna ports based at least in part on the one or more downlink reference signals.

4. The UE of claim 2, wherein the processing system is further configured to cause the UE to:
determine first channel state information for the uplink channel based at least in part on the one or more downlink reference signals and a first set of one or more time offsets indicated in the control information, wherein the first subset of the one or more antenna ports is based at least in part on the first channel state information; or
determine second channel state information for the downlink channel based at least in part on the one or more downlink reference signals and a second set of one or more time offsets indicated in the control information, wherein the second subset of the one or more antenna ports is based at least in part on the second channel state information.

5. The UE of claim 1, wherein the processing system is further configured to cause the UE to:
receive second control information indicating the calibration adjustment associated with the network entity based at least in part on the control information comprising an indication of the one or more conditions of the uplink channel between the UE and the network entity, wherein communication with the network entity is further in response to the second control information.

6. The UE of claim 1, wherein the processing system is further configured to cause the UE to:
determine one or more parameters of the one or more downlink reference signals for the one or more subsets of network entity antenna ports for uplink evaluation, for the one or more subsets of network entity antenna ports for downlink evaluation, or both; and
select the one or more antenna ports based at least in part on the one or more parameters of the downlink channel for the one or more subsets of network entity antenna ports for uplink evaluation, for the one or more subsets of network entity antenna ports for downlink evaluation, or both.

7. The UE of claim 1, wherein the processing system is further configured to cause the UE to:
select the one or more antenna ports from a plurality of antenna ports of the UE, the selection of the one or more antenna ports based at least in part on a spectral efficiency associated with the uplink channel, a transmission power availability, a maximum permissible exposure parameter, an uplink subband set, or a combination thereof, and wherein the one or more antenna ports are associated with the one or more subsets of network entity antenna ports for uplink evaluation.

8. The UE of claim 1, wherein the processing system is further configured to cause the UE to:
select the one or more antenna ports from a plurality of antenna ports based at least in part on the control information comprising an indication of the one or more subsets of network entity antenna ports for uplink evaluation, the one or more subsets of network entity antenna ports for downlink evaluation, or both; and
transmit an indication of a quantity of the one or more antenna ports for the one or more subsets of network entity antenna ports for uplink evaluation, downlink evaluation, or both, one or more computed parameters of the uplink channel or the downlink channel, a quantity of the one or more antenna ports selected for a portion of the one or more subsets of network entity antenna ports for uplink evaluation, downlink evaluation, or both, an identifier of the one or more antenna ports for the one or more subsets of network entity antenna ports for uplink evaluation, downlink evaluation, or both, an identifier of the one or more antenna ports for each subset in the portion of the one or more subsets of network entity antenna ports for uplink evaluation, downlink evaluation, or both, or a combination thereof.

9. The UE of claim 8, wherein the one or more subsets of network entity antenna ports for uplink evaluation, downlink evaluation, or both, are defined based at least in part on a common reference signal resource set or defined based at least in part on a plurality of reference signal resources.

10. The UE of claim 8, wherein the processing system is further configured to cause the UE to:
receive a feedback message based at least in part on the indication, wherein uplink reference signal control information, uplink grant information, or both is based at least in part on the feedback message.

11. The UE of claim 10, wherein the one or more downlink reference signals are one or more channel state information reference signals and the uplink reference signal control information is sounding reference signal control information.

12. The UE of claim 8, wherein the indication is transmitted via uplink control information, via a medium access control (MAC) control element, in response to an event trigger, or a combination thereof.

13. The UE of claim 1, wherein the one or more conditions of the uplink channel between the UE and the network entity comprises a noise plus interference covariance matrix.

14. The UE of claim 1, wherein:
the control information indicates the one or more conditions of the uplink channel between the UE and the network entity, and
the one or more conditions of the uplink channel are determined based at least in part on the calibration adjustment.

15. The UE of claim 1, wherein the control information further indicates a plurality of network entity antenna ports, a UE antenna subset selection parameter, one or more weights associated with the one or more conditions of the uplink channel or with one or more conditions of the downlink channel, a range of ranks associated with the downlink channel or with the uplink channel, a quantity of layers associated with the downlink channel or with the uplink channel, one or more subband sets associated with the uplink channel or with the downlink channel, one or more power parameters associated with the uplink channel, a pre-whitened reference signal parameter, one or more time offsets associated with the one or more subsets of network entity antenna ports for uplink evaluation, downlink evaluation, or both, or a combination thereof.

16. A network entity, comprising:
a processing system that includes processor circuitry and memory circuitry that stores code, the processing system configured to cause the network entity to:
transmit, from the network entity, control information indicating one or more conditions of an uplink channel between a user equipment (UE) and the network entity, a calibration adjustment associated with the network entity, one or more subsets of network entity antenna ports for uplink evaluation, or one or more subsets of network entity antenna ports for downlink evaluation, or a combination thereof;
transmit, from the network entity, one or more downlink reference signals via a downlink channel between the UE and the network entity; and
communicate, at the network entity, with the UE in response to the control information and the one or more downlink reference signals.

17. The network entity of claim 16, wherein, to communicate with the UE, the processing system is configured to cause the network entity to:
receive uplink communication associated with a first subset of antenna ports of a plurality of antenna ports of the UE; or
transmit downlink communication associated with a second subset of antenna ports of the plurality of antenna ports of the UE.

18. The network entity of claim 16, wherein the processing system is further configured to cause the network entity to:
transmit second control information indicating the calibration adjustment associated with the network entity based at least in part on the control information comprising an indication of the one or more conditions of the uplink channel between the UE and the network entity, wherein communication with the UE is further in response to the second control information.

19. The network entity of claim 16, wherein the one or more subsets of network entity antenna ports for uplink evaluation, downlink evaluation, or both, are defined based at least in part on a common reference signal resource set or defined based at least in part on a plurality of reference signal resources.

20. A method for wireless communications at a user equipment (UE), comprising:
receiving, at the UE, control information indicating one or more conditions of an uplink channel between the UE and a network entity, a calibration adjustment associated with the network entity, one or more subsets of network entity antenna ports for uplink evaluation, or one or more subsets of network entity antenna ports for downlink evaluation, or a combination thereof;
receiving, at the UE, one or more downlink reference signals via a downlink channel between the UE and the network entity; and
communicating, at the UE, with the network entity using one or more antenna ports selected by the UE in response to receiving the control information and the one or more downlink reference signals.
